(19) United States
(12) Patent Application Publication
(10) Pub. No.: US 2025/0350339 A1
(43) Pub. Date: Nov. 13, 2025

(54) USER EQUIPMENT INITIATED BEAM REPORTING

(71) Applicant: Nokia Technologies Oy, Espoo (FI)

(72) Inventors: Samantha CAPORAL DEL BARRIO, Aalborg (DK); Sami-Jukka HAKOLA, Oulu (FI); Timo KOSKELA, Oulu (FI)

(73) Assignee: Nokia Technologies Oy, Espoo (FI)

(21) Appl. No.: 19/200,892

(22) Filed: May 7, 2025

(30) Foreign Application Priority Data
May 7, 2024 (GB) 2406327.3

(51) Int. Cl. H04B 7/06; H04B 17/318; H04W 72/21; H04W 74/0833

(52) U.S. Cl. CPC H04B 7/06952; H04B 17/328; H04W 72/21; H04W 74/0833

(57) ABSTRACT

According to an aspect, a user equipment may obtain, from a network node, two different resource sets for an uplink signal for an uplink procedure and a user equipment initiated beam reporting procedure. The user equipment may measure beams to determine the best beam. The user equipment may identify a concurrent need to perform an uplink procedure transmission and a user equipment initiated beam report transmission, wherein the identifying comprises a determination whether at least one condition for triggering the user equipment initiated beam report transmission is met. The user equipment may transmit the uplink signal at least in part based on the best beam, the identified need and the two different resource sets.

### TECHNICAL FIELD

The disclosure relates generally to wireless communications and, more particularly but not exclusively, to user equipment initiated beam reporting.

### BACKGROUND

A network may configure a user equipment (UE) with a reference signal set for layer 1 reference signal received power (L1-RSRP) measurements. The reference signal set may comprise synchronization signal blocks (SSB) and/or channel state information reference signals (CSI-RS). From there, the UE would report best N reference signals in terms of RSRP value using periodic, semi-persistent or aperiodic reporting as configuring by network.

The medium access control (MAC) does not prioritize any random access channel (RACH) procedures and it is up to UE implementation whether to drop a current random access procedure if a new one is triggered. For a UE uplink transmission, there may be a conflict on priorities on the same slot/symbol between UE-initiated reporting (RACH to request an uplink resource) and RACH transmission for a contention free random access (CFRA) procedure.

### SUMMARY

The scope of protection sought for various example embodiments of the invention is set out by the independent claims. The example embodiments and features, if any, described in this specification that do not fall under the scope of the independent claims are to be interpreted as examples useful for understanding various example embodiments of the invention.

According to a first aspect, there is provided a user equipment. The user equipment comprises at least one processor and at least one memory storing instructions which, when executed by the at least one processor, cause the user equipment at least to: obtain, from a network node, two different resource sets for an uplink signal for an uplink procedure and a user equipment initiated beam reporting procedure; measure beams to determine the best beam; identify a concurrent need to perform an uplink procedure transmission and a user equipment initiated beam report transmission, wherein the identifying comprises a determination whether at least one condition for triggering the user equipment initiated beam report transmission is met; and transmit the uplink signal at least in part based on the best beam, the identified need and the two different resource sets.

In an example embodiment of the first aspect, the two different resource sets comprise a first set of resources configured only for the uplink procedure and a second set of resources configured for both the uplink procedure and the user equipment initiated beam reporting procedure.

In an example embodiment of the first aspect, in response to identifying the concurrent need to perform the uplink procedure transmission and the user equipment initiated beam report transmission, the user equipment is configured to transmit the uplink signal using the first set of resources.

In an example embodiment of the first aspect, the at least one memory store instructions which, when executed by the at least one processor, cause the user equipment at least to: determine among resources associated with downlink reference signal beams the resource associated with the earliest random access channel occasion; and transmit the uplink signal using the first set of resources configured only for the uplink procedure when the resource associated with the earliest random access channel occasion is associated with the best beam.

In an example embodiment of the first aspect, the at least one memory store instructions which, when executed by the at least one processor, cause the user equipment at least to: identify that the beam used for transmitting the uplink signal for the uplink procedure is the same as the best beam to be reported in a user equipment initiated beam report; and omit reporting of the user equipment initiated beam report or transmit the uplink signal only.

In an example embodiment of the first aspect, in response to identifying the concurrent need to perform the uplink procedure transmission and the user equipment initiated beam report transmission, the user equipment is configured to transmit the uplink signal using the second set of resources for both the uplink procedure and the user equipment initiated beam reporting procedure.

In an example embodiment of the first aspect, the at least one memory store instructions which, when executed by the at least one processor, cause the user equipment at least to: determine among resources associated with downlink reference signal beams the resource associated with the earliest random access channel occasion; and transmit the uplink signal using the second set of resources configured for both the uplink procedure and the user equipment initiated beam reporting procedure when the resource associated with the earliest random access channel occasion is not associated with the best beam.

In an example embodiment of the first aspect, the at least one memory store instructions which, when executed by the at least one processor, cause the user equipment at least to: identify that a beam used for transmitting the uplink signal for the uplink procedure is different than the best beam to be reported in a user equipment initiated beam report; and transmit the user equipment initiated beam report using the second set of resources.

In an example embodiment of the first aspect, the at least one memory store instructions which, when executed by the at least one processor, cause the user equipment at least to: receive a transmission configuration indicator from the network node, wherein the transmission configuration indicator indicates the second beam; and apply the second beam in subsequent transmission and/or receiving operations.

In an example embodiment of the first aspect, the second beam has a higher signal metric than that of the first beam.

In an example embodiment of the first aspect, the signal metric comprises a layer 1 or layer 3 reference signal received power value.

In an example embodiment of the first aspect, the signal metric comprises a layer 1 or layer 3 signal to interference and noise ratio value.

In an example embodiment of the first aspect, the best beam is a beam having a highest signal metric, wherein the signal metric comprises: a layer 1 or layer 3 reference signal received power value; or a layer 1 or layer 3 signal to interference and noise ratio value.

In an example embodiment of the first aspect, the uplink procedure comprises a contention free random access procedure.

In an example embodiment of the first aspect, the uplink procedure comprises a contention based random access procedure.

In an example embodiment of the first aspect, the at least two different resource sets may comprise different preambles.

According to a second aspect, there is provided a method. The method comprises obtaining, from a network node, two different resource sets for an uplink signal for an uplink procedure and a user equipment initiated beam reporting procedure; measuring beams to determine the best beam; identifying a concurrent need to perform an uplink procedure transmission and a user equipment initiated beam report transmission, wherein the identifying comprises a determination whether at least one condition for triggering the user equipment initiated beam report transmission is met; and transmitting the uplink signal at least in part based on the best beam, the identified need and the two different resource sets.

In an example embodiment of the second aspect, the two different resource sets comprise a first set of resources configured only for the uplink procedure and a second set of resources configured for both the uplink procedure and the user equipment initiated beam reporting procedure.

In an example embodiment of the second aspect, in response to identifying the concurrent need to perform the uplink procedure transmission and the user equipment initiated beam report transmission, transmitting the uplink signal using the first set of resources.

In an example embodiment of the second aspect, the method further comprises determining among resources associated with downlink reference signal beams the resource associated with the earliest random access channel occasion; and transmitting the uplink signal using the first set of resources configured only for the uplink procedure when the resource associated with the earliest random access channel occasion is associated with the best beam.

In an example embodiment of the second aspect, the method further comprises identifying that the beam used for transmitting the uplink signal for the uplink procedure is the same as the best beam to be reported in a user equipment initiated beam report; and omitting reporting of the user equipment initiated beam report or transmitting the uplink signal only.

In an example embodiment of the second aspect, in response to identifying the concurrent need to perform the uplink procedure transmission and the user equipment initiated beam report transmission, transmitting the uplink signal using the second set of resources for both the uplink procedure and the user equipment initiated beam reporting procedure.

In an example embodiment of the second aspect, the method further comprises among determining resources associated with downlink reference signal beams the resource associated with the earliest random access channel occasion; and transmitting the uplink signal using the second set of resources configured for both the uplink procedure and the user equipment initiated beam reporting procedure when the resource associated with the earliest random access channel occasion is not associated with the best beam.

In an example embodiment of the second aspect, the method further comprises identifying that a beam used for transmitting the uplink signal for the uplink procedure is different than the best beam to be reported in a user equipment initiated beam report; and transmitting the user equipment initiated beam report using the second set of resources.

In an example embodiment of the second aspect, the method further comprises receiving a transmission configuration indicator from the network node, wherein the transmission configuration indicator indicates the second beam; and applying the second beam in subsequent transmission and/or receiving operations.

In an example embodiment of the second aspect, the second beam has a higher signal metric than that of the first beam.

In an example embodiment of the second aspect, the signal metric comprises a layer 1 or layer 3 reference signal received power value.

In an example embodiment of the second aspect, the signal metric comprises a layer 1 or layer 3 signal to interference and noise ratio value.

In an example embodiment of the first aspect, the best beam is a beam having a highest signal metric, wherein the signal metric comprises: a layer 1 or layer 3 reference signal received power value; or a layer 1 or layer 3 signal to interference and noise ratio value

In an example embodiment of the second aspect, the uplink procedure comprises a contention free random access procedure.

In an example embodiment of the second aspect, the uplink procedure comprises a contention based random access procedure.

In an example embodiment of the second aspect, the at least two different resource sets may comprise different preambles.

According to a third aspect, there is provided a computer program comprising instructions causing an apparatus to perform the method of the second aspect.

According to a fourth aspect, there is provided a non-transitory computer-readable medium comprising a computer program comprising instructions causing an apparatus to perform the method of the second aspect.

According to a fifth aspect, there is provided a user equipment comprising means for obtaining, from a network node, two different resource sets for an uplink signal for an uplink procedure and a user equipment initiated beam reporting procedure; means for measuring beams to determine the best beam; means for identifying a concurrent need to perform an uplink procedure transmission and a user equipment initiated beam report transmission, wherein the identifying comprises a determination whether at least one condition for triggering the user equipment initiated beam report transmission is met; and means for transmitting the uplink signal at least in part based on the best beam, the identified need and the two different resource sets.

### DESCRIPTION OF THE DRAWINGS

The accompanying drawings, which are included to provide a further understanding of the embodiments and constitute a part of this specification, illustrate embodiments and together with the description help to explain the principles of the embodiments. In the drawings:

FIG. 1 illustrates a signalling diagram between a network and a user equipment.

FIG. 2A illustrates a block diagram of a user equipment according to an example embodiment.

FIG. 2B illustrates block diagram of a network node according to an example embodiment;

FIG. 3 illustrates a signalling diagram between a transmission reception point and a user equipment according to an example embodiment.

FIG. 4 illustrates a signalling diagram between a user equipment and a transmission reception point comprising three different beams according to an example embodiment.

FIG. 5 illustrates a signalling diagram between a user equipment and a transmission reception point comprising three different beams according to an example embodiment.

FIG. 6A illustrates a method according to an example embodiment.

FIG. 6B illustrates a method according to an example embodiment.

FIG. 6C illustrates a method according to an example embodiment.

FIG. 7A illustrates a method according to an example embodiment.

FIG. 7B illustrates a method according to an example embodiment.

Like reference numerals are used to designate like parts in the accompanying drawings.

### DETAILED DESCRIPTION

Reference will now be made in detail to embodiments, examples of which are illustrated in the accompanying drawings. The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

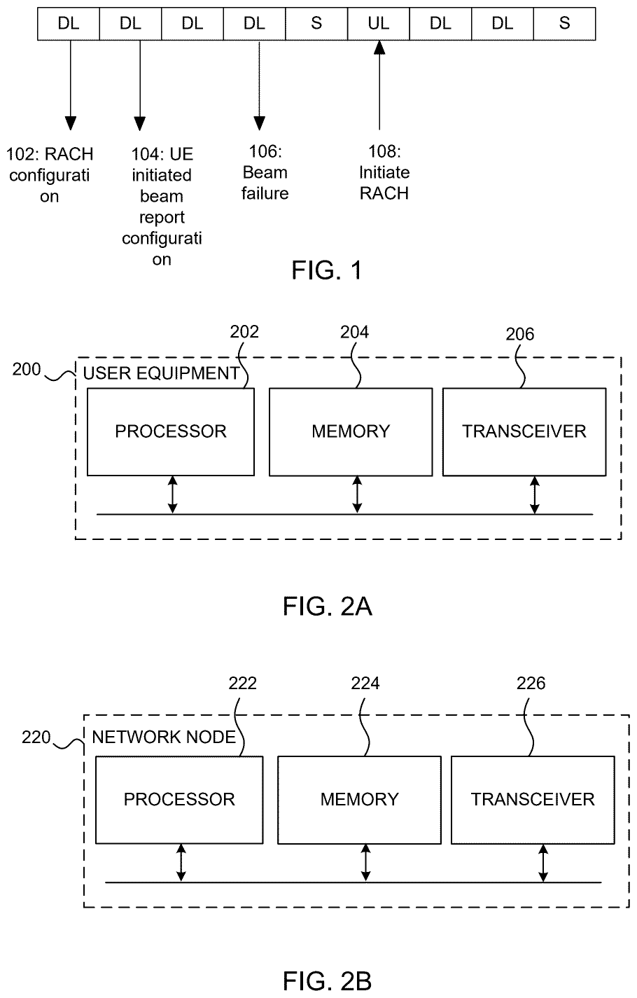

FIG. 1 illustrates a signalling diagram between a network and a user equipment (UE).

At 102, the network may configure UE 200 with random access channel (RACH) resources. The RACH resources may be, for example, contention free random access (CFRA) resources. In a CFRA procedure, the network configures the UE with dedicated resources and/or a dedicated preamble, which would identify the UE in a pool of UEs to the network.

At 104, the network may configure the UE with resources for a user equipment initiated beam report (UEIBR). The UEIBR may comprise information on one or more beams projected by a TRP, that the UE determines to be the ‘preferred beams’, i.e., beams that comprise the best performance parameters such as channel state information (CSI) parameters.

At 106, the UE 200 may experience a beam failure. At 108 in the uplink transmission, there may be a conflict on priorities on the same slot/symbol between UE-initiated reporting (RACH to request uplink resource) and RACH transmission for CFRA procedure.

Various example embodiments discussed herein may be established, for example, in conjunction with standard protocols presented in TS 38.211, TS 38.212, TS 38.214, TS 38.321 and TS 38.331. In other words, TS 38.211, TS 38.212, TS 38.214, TS 38.321 and TS 38.331 may be referred for further information on how to implement various example embodiments.

In the following, various example embodiments will be discussed. At least some of these example embodiments described herein may disclose a solution in which a UE may be configured to obtain at least one resource set, and identify a concurrent need to perform an uplink procedure transmission and a UE initiated beam report transmission. Furthermore, the UE may be configured to transmit an uplink signal at least in part based on the identified need and the at least one resource set. The uplink signal may comprise, for example, a RACH preamble that initiates RACH procedure, or alternatively, the uplink signal may comprise a RACH preamble that indicates to the network that the UE requests uplink resources for transmitting the UEIBR, wherein the UEIBR may comprise information that the network may need to use to identify one or more beams that are better suited for the UE than the current beam, for example. It will be further noted that the UEIBR may also comprise the UE-initiated and/or event-driven beam management reports.

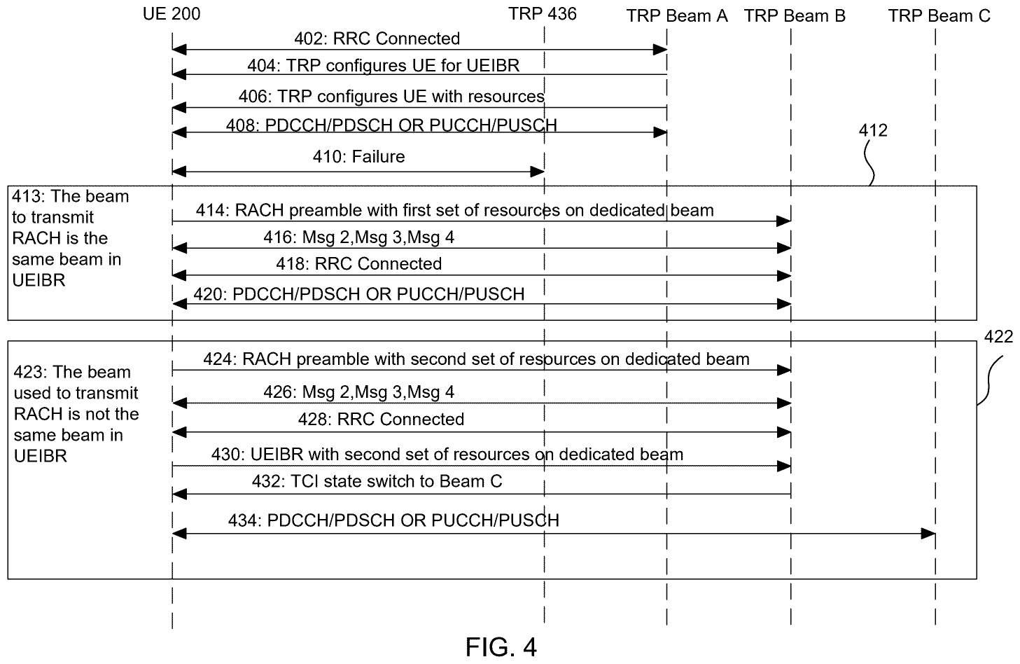

The at least one resource set may comprise resources for transmitting the UEIBR time (e.g. and frequency information) and transmitting the uplink signal. In some embodiments, the at least one resource set may be for the uplink signal only. The UE may determine, whether to transmit the UEIBR (based on the need) or not, and to transmit the uplink signal only, or transmit the UEIBR as well, in for example, a later uplink occasion. FIGS. 3, 4 and 5 illustrate various examples, how the UEIBR may be transmitted.

Furthermore, various example embodiments may disclose a solution in which a UE may be configured to obtain, from a network node, two different resource sets for an uplink signal for an uplink procedure and a request of uplink resources for a user equipment initiated beam reporting procedure; identify a concurrent need to perform an uplink procedure transmission and request uplink resources for a user equipment initiated beam report transmission; and transmit an uplink signal at least in part based on the identified need and the two different resource sets.

Furthermore, various example embodiments may disclose a solution in which a UE may be configured to obtain, from a network node, two different resource sets for an uplink signal for an uplink procedure and a user equipment initiated beam reporting procedure; measure beams to determine the best beam; identify a concurrent need to perform an uplink procedure transmission and a user equipment initiated beam report transmission, wherein the identifying comprises a determination whether at least one condition for triggering the user equipment initiated beam report transmission is met; and transmit the uplink signal at least in part based on the best beam, the identified need and the two different resource sets

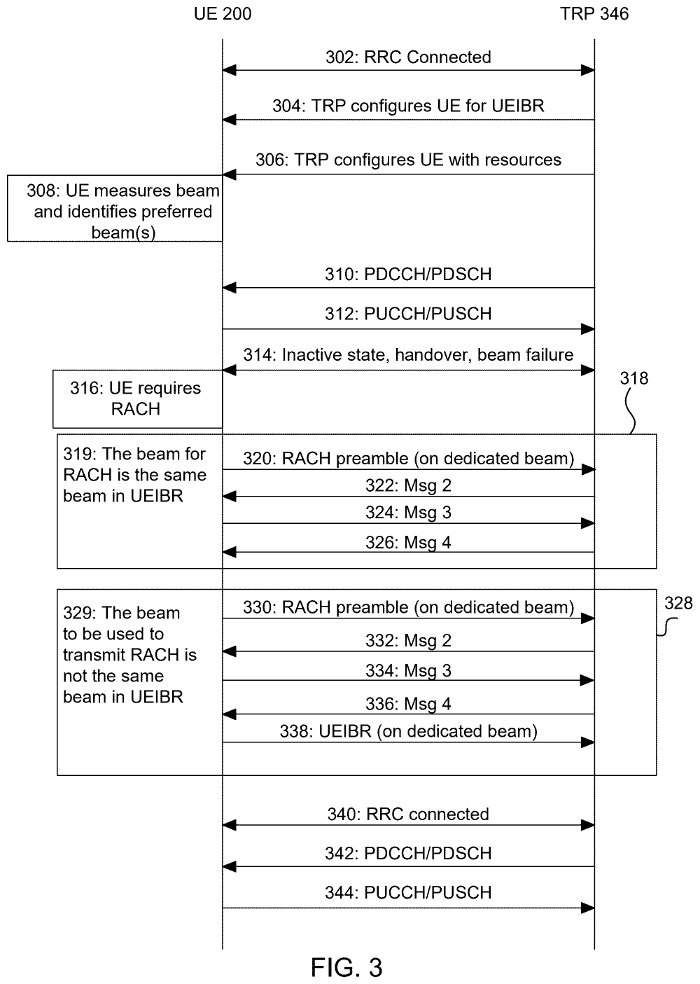

FIG. 2A is a block diagram of user equipment (UE) 200 according to an example embodiment. The UE 200 may comprise, for example, a mobile phone, a smartphone, an apparatus, a tablet computer, a smart watch, a hand-held device, a portable device or a wearable device.

The UE 200 may comprise one or more processors 202 and one or more memories 204 that comprise computer program code. The UE 200 may also include other elements, such as a transceiver 206 configured to enable the UE 200 to transmit and/or receive information to/from other devices, as well as other elements not shown in FIG. 2A. In one example, the UE 200 may use the transceiver 206 to transmit or receive signalling information and data in accordance with at least one cellular communication protocol. The transceiver 206 may be configured to provide at least one wireless radio connection, such as for example a 3GPP mobile broadband connection (for example, 5G or 6G). The transceiver 206 may comprise, or be configured to be coupled to, at least one antenna to transmit and/or receive radio frequency signals.

Although the UE 200 is depicted to include only one processor 202, the UE 200 may include more than one processor. In an embodiment, the memory 204 is capable of storing instructions, such as an operating system and/or various applications. Furthermore, the memory 204 may include a storage that may be used to store, for example, at least some of the information and data used in the disclosed embodiments.

Furthermore, the processor 202 is capable of executing the stored instructions. In an embodiment, the processor 202 may be embodied as a multi-core processor, a single core processor, or a combination of one or more multi-core processors and one or more single core processors. For example, the processor 202 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, a neural network (NN) chip, an artificial intelligence (AI) accelerator, a tensor processing unit (TPU), a neural processing unit (NPU), or the like. In an embodiment, the processor 202 may be configured to execute hard-coded functionality. In an embodiment, the processor 202 is embodied as an executor of software instructions, wherein the instructions may specifically configure processor 202 to perform the algorithms and/or operations described herein when the instructions are executed.

The memory 204 may be embodied as one or more volatile memory devices, one or more non-volatile memory devices, and/or a combination of one or more volatile memory devices and non-volatile memory devices. For example, the memory 204 may be embodied as semiconductor memories (such as mask ROM, PROM (programmable ROM), EPROM (erasable PROM), flash ROM, RAM (random access memory), etc.).

The UE 200 may comprise any of various types of devices used directly by an end user entity and capable of communication in a wireless network, such as a user equipment (UE). Such devices include but are not limited to smartphones, tablet computers, smart watches, lap top computers, internet-of-things (IoT) devices, massive machine-to-machine (M2M) devices, massive machine type communications (mMTC) devices, industrial internet-of-things (IIoT) devices, enhanced mobile broadband (eMBB) devices, ultra-reliable low-latency communication (URLLC) devices, relay nodes (such as integrated access and backhaul nodes) configured to facilitate backhaul connections, and/or devices mounted in vehicles, etc.

When executed by the at least one processor 202, instructions stored in at least one memory 204 may cause the UE 200 at least to obtain, from a network node, at least one resource set. The at least one resource set may be associated, for example, with a user equipment initiated beam reporting procedure.

The user equipment initiated beam reporting procedure may comprise a procedure that comprises communications between the network node and the UE 200, that causes the network node to switch beams by which a future physical downlink control channel (PDCCH), physical downlink shared channel (PDSCH), physical uplink communication channel (PUCCH), and/or physical uplink shared Shannel (PUSCH) communications are performed on.

Alternatively, or in addition, the instructions stored in the at least one memory 204 may cause the UE 200 at least to obtain, from the network node, two different resource sets for an uplink signal for an uplink procedure and a request of uplink resources for a user equipment initiated beam reporting procedure.

In an example embodiment, the instructions stored in the at least one memory 204, when executed by the at least one processor 202 may cause the UE 200 to measure beams to determine the best beam. In other words, the UE 200 may measure beams from, for example, synchronization signal blocks (SSB) obtained for a network node. The SSB's may comprise CSI parameters by which the best beam may be determined. The best beam may a beam having a highest signal metric. The signal metric may comprise, for example, a layer 1 or layer 3 reference signal received power value or a layer 1 or layer 3 signal to interference and noise ratio value.

Furthermore, the instructions, when executed by the at least one processor 202 may further cause the UE 200 to identify a concurrent need to perform an uplink procedure transmission and a user equipment initiated beam report transmission.

In another example, when executed by the at least one processor 202 may further cause the UE 200 to identify a concurrent need to perform an uplink procedure transmission and request uplink resources for a user equipment initiated beam report transmission.

The concurrent need to perform an uplink procedure transmission and a user equipment initiated beam report transmission may comprise, for example, comparing performance parameters (such as CSI parameters) of a set of beams projected by the network node, and identifying a best beam of those beams. In some embodiments, the concurrent need to perform an uplink procedure transmissions and a user equipment initiated beam report transmission may comprise, for example, comparing the set of beams projected by the network node to a beam that current and/or previous communications were performed on (for example, comparing the performance parameters of the set of beams in contrast to a beam that the UE 200 has established a RRC connection with).

In other words, the UE 200 may determine that the current, established beam is not suitable for further communications. This may be due to, for example, re-location of the UE 200, or increased traffic to the network node in the vicinity of the UE 200.

In an example embodiment, the instructions stored in the at least one memory 204, when executed by the at least one processor 202 may cause the UE 200 to identify a concurrent need to perform an uplink procedure transmission and a user equipment initiated beam report transmission, wherein the identifying comprises a determination whether at least one condition for triggering the user equipment initiated beam report transmission is met. The at least one condition may comprise, for example, a condition that the best beam is x dB better than the current beam.

Furthermore, the instructions, when executed by the at least one processor 202 may cause the UE 200 to transmit an uplink signal at least in part based on the identified need and the two different resource sets.

Alternatively, or in addition, in an example embodiment, the instructions stored in the at least one memory 204, when executed by the at least one processor 202 may cause the UE 200 to transmit the uplink signal at least in part based on the best beam, the identified need and the two different resource sets.

The uplink signal may comprise, for example, the UEIBR report and/or an uplink signal separately. For example, transmitting the uplink signal may comprise transmitting two uplink signals, one for transmitting an uplink signal that initiates a communication procedure as per, for example, technical specification (such as RACH), and the other one comprising the UEIBR, which may indicate to the network node that a beam switching operation would be preferred by the UE 200. Alternatively, transmitting the uplink signal may comprise transmitting one uplink signal for initiating the communication procedure (for example, the RACH). In other words, transmitting the uplink signal may comprise transmitting the uplink signal only or transmitting both the uplink signal and user equipment initiated beam report.

Alternatively, or in addition, the two different resource sets may comprise a first resource set configured for both the uplink procedure and the user equipment initiated beam reporting procedure and a second resource set configured only for the uplink procedure.

In an embodiment, the at least one resource set may comprise one resource set, and the instructions, when executed by at least one processor 202, may further cause UE 200 at least to: obtain, from the network node, an indication indicating whether the resource set is for transmitting the uplink signal only or transmitting both the uplink signal and user equipment initiated beam report. For example, based on the indication, the network may determine whether to expect a UEIBR or not.

In an embodiment, transmitting the uplink signal comprises transmitting the uplink signal only or transmitting both the uplink signal and the request of uplink resources for the user equipment initiated beam report.

In an embodiment, the two different resource sets comprises a first resource set configured only for the uplink procedure and a second resource set configured for both the uplink procedure and the request of uplink resources for the user equipment initiated beam reporting procedure.

In an embodiment, in response to identifying the concurrent need to perform the uplink procedure transmission and request uplink resources for the user equipment initiated beam report transmission, the instructions, when executed by at least one processor 202, may further cause UE 200 at least to: transmit the uplink signal using the second resource set.

In an embodiment, the instructions, when executed by at least one processor 202, may further cause UE 200 at least to, in response to transmitting the uplink signal using the second resource set, receive, from the network node, the uplink resources for the user equipment initiated beam report transmission; and transmit the user equipment initiated beam report using the uplink resources. In other words, using the second resource set for transmitting the uplink signal triggers the network node to allocate resources for the UEIBR report, and transmit the uplink resources to the UEIBR, by, for example, using Msg 2 or a Downlink Control Information, DCI, message.

In an embodiment, the first resource set comprises a first set of uplink preambles and/or occasions configured only for the uplink procedure and the second resource set comprises a second set of uplink preambles and/or occasions configured for both the uplink procedure and the request of uplink resources for the user equipment initiated beam reporting procedure.

In some embodiments, the at least one resource set may comprise at least one set of uplink preambles and/or occasions. The at least one resource set may comprise the previously described two different resource set, or only one from the two different resource sets. If the at least one resource set is only for an uplink procedure (e.g., RACH), the at least one resource set may comprise a preamble resource ID, a RACH occasion or both. The preamble resource ID and/or the RACH occasion may be for CFRA procedure. If the at least one resource set is for both an uplink procedure and for transmitting the UEIBR, the at least one resource set may comprise a preamble resource ID, a RACH occasion or both (for CFRA) and the at least one resource set may further comprise uplink resources for transmitting the UEIBR.

In some embodiments, the at least one resource set may comprise two different resource sets, wherein the two different resource sets comprise a first resource set configured for both the uplink procedure and the user equipment initiated beam reporting procedure and a second resource set configured only for the uplink procedure. In other words, two different resource sets may be obtained from the network node, and one resource set is configured only for the uplink procedure and the other is configured for both the uplink procedure and transmitting the UEIBR.

In some embodiments, in response to identifying the concurrent need to perform the uplink procedure transmission and the user equipment initiated beam report transmission, the user equipment is configured to transmit the uplink signal using the first resource set.

In some embodiments, in response to identifying the concurrent need to perform the uplink procedure transmission and the user equipment initiated beam report transmission, the user equipment may be configured to transmit the uplink signal using the first set of uplink preambles and/or occasions. In other words, using the first set of uplink preambles and/or occasions indicates to the network node that there is no need to transmit the UEIBR.

In an example embodiment, the at least one memory 204 stores instructions which, when executed by the at least one processor 202, may cause the UE 200 to identify that the beam used for transmitting the uplink signal for the uplink procedure is the same as the beam to be reported in a user equipment initiated beam report and omit reporting of the user equipment initiated beam report or transmit the uplink signal only. In other words, the UE 200 may have identified that a beam, by which RRC connection has been established, is the best beam, or a beam that satisfies some performance conditions (i.e., the beam is ‘good enough’), and therefore communications may proceed on that beam and sending then UEIBR is not required.

Alternatively, or in addition, the instructions stored in the at least one memory 204, when executed by the at least one processor 202, may cause the UE 200 determine among resources associated with downlink reference signal beams the resource associated with the earliest random access channel occasion; and transmit the uplink signal using the first set of resources configured only for the uplink procedure when the resource associated with the earliest random access channel occasion is associated with the best beam.

Alternatively, or in addition, the instructions stored in the at least one memory 204, when executed by the at least one processor 202, may cause the UE 200 to identify that the beam used for transmitting the uplink signal for the uplink procedure is the same as the best beam to be reported in the user equipment initiated beam report; and omit reporting of the user equipment initiated beam report.

In some embodiments, in response to identifying the concurrent need to perform the uplink procedure transmission and the user equipment initiated beam report transmission, the user equipment may be configured to transmit the uplink signal using the second resource set configured for both the uplink procedure and the user equipment initiated beam reporting procedure. For example, when the UE 200 has obtained the two resource sets (as per above-described embodiment(s)), the UE 200 may transmit the UEIBR and the uplink transmission using the second resource set.

In an example embodiment, the at least one memory 204 stores instructions which, when executed by the least one processor 202, may cause the UE 200 to identify that a first beam used for transmitting the uplink signal for the uplink procedure is different than a second beam to be reported in a user equipment initiated beam report; and transmit the user equipment initiated beam report using the second resource set. In other words, the uplink transmission may be performed on a first beam, but upon receiving the UEIBR, the network node may determine to initiate, based on the UEIBR, a beam-switching operation to perform, for example, upcoming PDCCH/PDSCH and/or PUCCH/PUSCH operations on a second beam.

Alternatively, or in addition to the previously described embodiment, the at least one memory 204 may store instructions which, when executed by the least one processor 202, may cause the UE 200 to identify that a first beam to be used for transmitting the uplink signal is different than a second beam to be reported in a user equipment initiated beam report; and transmit the uplink signal using the second resource set.

Alternatively, or in addition to the two previously described embodiments, the at least one memory 204 may store instructions which, when executed by the at least one processor 202, may cause the UE 200 determine among resources associated with downlink reference signal beams the resource associated with the earliest random access channel occasion; and transmit the uplink signal using the second set of resources configured for both the uplink procedure and the user equipment initiated beam reporting procedure when the resource associated with the earliest random access channel occasion is not associated with the best beam.

Alternatively, or in addition to the two previously described embodiments, the at least one memory 204 may store instructions which, when executed by the at least one processor 202, may cause the UE 200 to identify that a beam used for transmitting the uplink signal for the uplink procedure is different than the best beam to be reported in a user equipment initiated beam report; and transmit the user equipment initiated beam report using the second resource set.

In an example embodiment, the at least one memory 204 may store instructions which, when executed by the at least one processor 202, may further cause the UE 200 to receive a transmission configuration indicator (TCI) from the network node, wherein the TCI indicates the second beam; and apply the second beam in subsequent transmission and/or receiving operations. In other words, the TCI may be used to indicate the beam by which upcoming PDCCH/PDSCH and/or PUCCH/PUSCH operations should be performed on.

Alternatively, or in addition to the two previously described embodiments, the at least one memory 204 may store instructions which, when executed by the at least one processor 202, may cause the UE 200 to receive a transmission configuration indicator from the network node, wherein the transmission configuration indicator indicates the best beam; and apply the best beam in subsequent transmission and/or receiving operations.

In some embodiments, the second beam may have a higher signal metric than that of the first beam. The signal metric may comprise a layer 1 or a layer 3 reference signal received power value. Alternatively, or in addition, the signal metric may comprise a layer 1 or a layer 3 signal to interference and noise ratio value. In other words, there may be multiple metrics, by which a quality of beam is measured by, and UE 200 may determine one or more preferred beams (the second beam), which may, or may not be the same beam that the uplink transmission is performed on.

In some embodiments, the best beam is a beam having a highest signal metric, wherein the signal metric comprises a layer 1 or layer 3 reference signal received power value; or layer 1 or layer 3 signal to interference and noise ratio value.

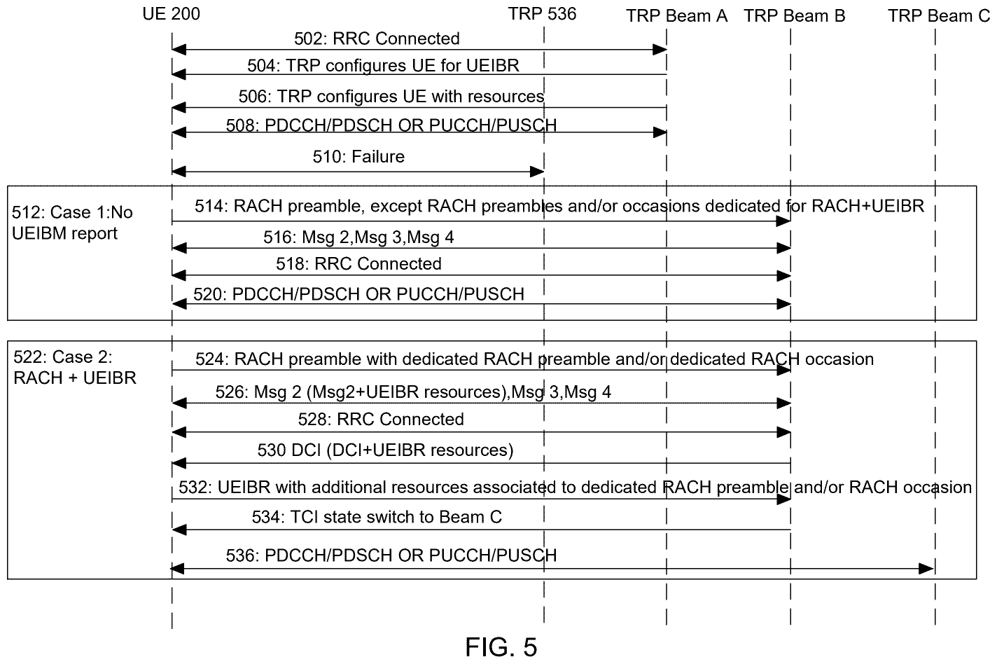

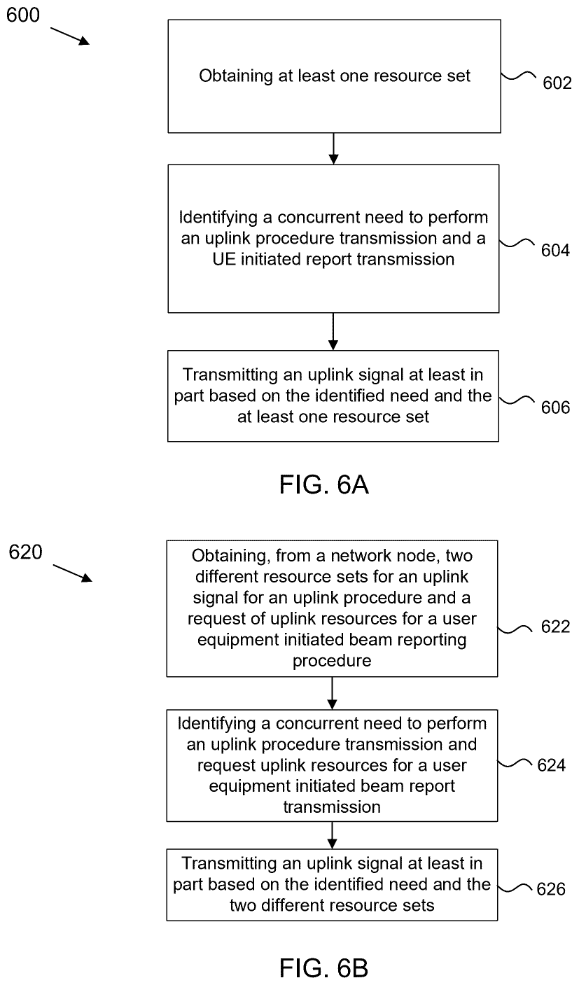

In an example embodiment, the uplink procedure comprises a contention free random access (CFRA) procedure or a contention based random access (CBRA) procedure. Various example embodiments may be implemented on both the CFRA and CBRA. However, it will be noted that examples provided herein mostly refer to CFRA to retain a cohesive structure in the description. More detailed examples are described in reference to FIG. 3, FIG. 4 and FIG. 5.

The uplink preambles and/or occasions for an uplink signal for an uplink procedure may comprise, for example, a RACH preamble, such as a dedicated preamble to initiate a contention free random access procedure (CFRA). Or alternatively, it may be a preamble for contention based random access (CBRA) procedure. However, for a CBRA procedure, the UE 200 may have previously transmitted a randomly chosen preamble for a preset pool of preambles, to the network, and the network may respond by transmitting a preamble that is either the same preamble, or another preamble, if the network node has already established communications with another UE with the same preamble.

FIG. 2B illustrates block diagram of a network node 220 according to an example embodiment.

The network node 220 may comprise one or more processors 222 and one or more memories 224 that comprise computer program code. The network node 220 may also include other elements, such as a transceiver 226 configured to enable network node 220 to transmit and/or receive information to/from other devices, as well as other elements not shown in FIG. 2B. In one example, the network node 220 may use the transceiver 226 to transmit or receive signalling information and data in accordance with at least one cellular communication protocol. The transceiver 226 may be configured to provide at least one wireless radio connection, such as for example a 3GPP mobile broadband connection (for example, 5G or beyond). The transceiver 226 may comprise, or be configured to be coupled to, at least one antenna to transmit and/or receive radio frequency signals.

Although the network node 220 is depicted to include only one processor 222, the network node 220 may include more than one processor. In an embodiment, The memory 224 is capable of storing instructions, such as an operating system and/or various applications. Furthermore, the memory 224 may include a storage that may be used to store, for example, at least some of the information and data used in the disclosed embodiments.

Furthermore, the at least one processor 222 is capable of executing the stored instructions. In an embodiment, the processor 222 may be embodied as a multi-core processor, a single core processor, or a combination of one or more multi-core processors and one or more single core processors. For example, the processor 222 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, a neural network (NN) chip, an artificial intelligence (AI) accelerator, a tensor processing unit (TPU), a neural processing unit (NPU), or the like. In an embodiment, processor 222 may be configured to execute hard-coded functionality. In an embodiment, processor 222 is embodied as an executor of software instructions, wherein the instructions may specifically configure processor 222 to perform the algorithms and/or operations described herein when the instructions are executed.

The memory 224 may be embodied as one or more volatile memory devices, one or more non-volatile memory devices, and/or a combination of one or more volatile memory devices and non-volatile memory devices. For example, the memory 224 may be embodied as semiconductor memories (such as mask ROM, PROM (programmable ROM), EPROM (erasable PROM), flash ROM, RAM (random access memory), etc.).

The network node 220 may comprise a base station, a transmission reception point, TRP, a network apparatus, and/or a relay node. The base station may include, for example, a 5G or 6G base station (gNB) or any such device providing an air interface for the UE 200 to connect to a wireless network via wireless transmissions.

It is to be noted that when referring to, for example, “providing”, “transmitting”, “receiving” or “obtaining” etc., it may comprise the network node 220 and the UE 200 communicating information via, for example, at least one transceiver 206 and at least one transceiver 226.

When executed by the at least one processor 222, instructions stored in the at least one memory 224 may cause the network node 220 to transmit to the UE 200 at least one resource set; and receive an uplink signal using the at least one resource set. The at least one resource set may comprise the first resource set and the second resource set described in reference to the previous examples of UE 200.

Alternatively, or in addition to the above example embodiment, the instructions stored in the at least one memory 224, when executed by the at least one processor 222, may cause the network node 220 at least to transmit, to a user equipment, two different resource sets for an uplink signal for an uplink procedure and a request of uplink resources for a user equipment initiated beam reporting procedure; and receive, from the user equipment, the uplink signal using one of the two different resource sets.

FIG. 3 illustrates a signalling diagram according to an example embodiment. In FIG. 3, the UE 200 is configured to communicate with a transmission reception point (TRP) 346.

At 302, the TRP 346 and the UE 200 have established a RRC connection, and at 304, the TRP 346 configures the UE 200 to user equipment initiated beam reporting.

At 306, the TRP 346 configures the UE 200 with resources. For example, one resource set for both RACH procedure and a user equipment initiated beam reporting procedure, or two different resource sets, wherein the two different resource sets comprise a first resource set configured only for the uplink procedure and a second resource set configured for both the uplink procedure and the user equipment initiated beam reporting. In case one resource set is configured, the TRP 346 may indicate whether the source is for uplink procedure, or it is for both the uplink procedure and UEIBR procedure. Alternatively, the TRP 346 may configure the UE 200 with two different sets of uplink preambles and/or occasions for an uplink signal for an uplink procedure and a user equipment initiated beam reporting procedure as described in the previous examples.

At 308, the UE 200 may be configured to measure beams and identify one or more (preferred) beams that may be reported in the UEIBR. In an example embodiment, the UE 200 may be configured to measure the beams to determine the best beam. The best beam may be a beam having a highest signal metric. The signal metric may comprise, for example, a layer 1 or layer 3 reference signal received power value or a layer 1 or layer 3 signal to interference and noise ratio value.

At 310 and 312, the UE 200 and the TRP 346 may communicate via various standard channels, such as PDCCH/PDSCH and/or PUCCH/PUSCH.

At 314, the UE 200 and the TRP 346 may experience a communication failure, such as an inactive state, handover or a beam failure, which causes the UE 200 to recognize 316 a need to trigger a RACH procedure (to re-establish communications, for example). Further examples for triggering a RACH procedure may comprise, for example, an initial access from RRC_IDLE, transition from RRC_inactive to RRC_connected, RRC connection re-establishment, handover, synchronous reconfiguration, timing alignment during Scell addition, DL out of sync (i.e., the TRP 346 triggers PDCCH order), UL out of sync, scheduling request (SR), max transmission reached, no PUCCH configuration for SR, NR cell addition for NSA networking and/or a beam recovery.

A box 318 encloses various operations (operations 320-326) of a first case, where the UE 200 has identified that there is no need to send the UEIBR.

At 319, the UE 200 may choose a dedicated beam for, for example, a RACH preamble transmission (e.g. CFRA) only, which may correspond to a best measured beam (at 308) by the UE 200 (highest L1-RSRP/L1-SINR/PHR/RI etc.). The RACH preamble may be, for example, one preamble from the two different sets of uplink preambles and/or occasions for an uplink signal for an uplink preambles and the user equipment initiated beam reporting procedure obtained by the UE 200 in reference to previously described embodiments.

At 320, the UE 200 may transmit the RACH preamble on the dedicated beam, and at 322 UE 200 may receive Msg 2 from the TRP 346. At 324, the UE 200 may transmit Msg 3 to the TRP 346 and at 326, the UE 200 may receive Msg 4 from the TRP 346 to conclude the CFRA procedure.

A box 328 encloses various operations (operations 330-338) of a second case, wherein the UE 200 has identified the need to send the UEIBR.

At 329, the UE 200 may choose to transmit RACH (e.g. CFRA) on a dedicated beam that is not reported in the UEIBR, and use, for example, the second resource set for transmitting RACH on the dedicated beam, and transmit the UEIBR on the dedicated beam.

At 330, the UE 200 may send the RACH preamble on the dedicated beam, wherein the RACH preamble may be the other one from two different sets of uplink preambles and/or occasions for an uplink signal for an uplink procedure and a user equipment initiated beam reporting procedure as described in reference to previous embodiments.

At 332, the TRP 346 sends Msg 2 to the UE 200 and at 334, the UE 200 sends Msg 3 to the TRP 346.

At 336, the TRP 346 sends Msg 4 to the UE 200 and at 338, the UE 200 may send the UEIBR report on the (currently) dedicated beam.

At 340, the RRC connection has been established (or re-established), and at 342 and 344, the TRP 346 and the UE 200 may proceed with standard PDCCH/PDSCH and/or PUCCH/PUSCH communications.

FIG. 4 illustrates a signalling diagram between a user equipment 200 and a transmission reception point 436 comprising three different beams according to an example embodiment. FIG. 4 illustrates a TRP 436 and three TRP beams (TRP Beam A, TRP Beam B and TRP Beam C), by which communications may be performed on.

Operations 402 to 410 illustrate the same operations/steps, as operations 302-314 of FIG. 3, i.e., standard operations that may lead to the UE 200 either identifying the need to transmit a UEIBR or not. It will be noted that while FIG. 4 does not illustrate the operation 308 (beam measurement) and the operation 316 (need to trigger RACH), for the purposes of clarity, FIG. 4 may implicitly comprise these operations.

It will be further noted, that PDCCH/PDSCH and/or PUCCH/PUSCH operations are illustrated as a single arrow to indicate both uplink and downlink operations to maintain clarity.

Furthermore, RACH messages Msg2, Msg 3 and Msg 4 are illustrated as a single arrow to indicate both uplink and downlink operations.

Operations 402 to 408 are illustrated as being transmitted and/or received on the TRP Beam A. In other words, communications are at first performed on the TRP Beam A, until a failure is experienced at 410 (for example, the failure may comprise a handover, beam failure, inactive state or the like as described above).

At 402, the UE 200 is RRC connected to TRP Beam A and at 404, the TRP 436 configures (on the TRP Beam B) the UE 200 for UEIBR transmission.

At 406, the TRP 436 configures the UE 200 with RACH resources and UEIBR resources. The TRP 436 can also configure the UE 200 with one resource. The TRP 436 may indicate whether the source is a RACH resource, or it is a common resource for both the RACH procedure and a UEIBR procedure. In other words, the TRP 436 may transmit the two different resource sets (comprising, for example, two different sets of uplink preambles and/or occasions for an uplink signal) or the TRP 436 may transmit the at the resource set.

At 408, the UE 200 and the TRP 436 communicate PDCCH/PDSCH and/or PUCCH/PUSCH on TRP Beam B.

After experiencing the failure at 410, the UE 200 may perform operations enclosed by a box 412 (case 1), or perform operations enclosed by a box 422 (case 2).

The box 412 encapsulates operations for a case, where the UE 200 has identified that there is no need to transmit a UEIBR.

At 413, the UE 200 may choose a dedicated beam for, for example, a RACH preamble transmission (e.g. CFRA) only, which may correspond to a best measured beam (at 308) by the UE 200 (highest L1-RSRP/L1-SINR/PHR/RI etc.). The RACH preamble may be, for example, one preamble from the two different sets of uplink preambles and/or occasions obtained by the UE 200 in reference to previously described embodiments.

At 414, the UE 200 transmits a RACH preamble (for example, based on the resources obtained earlier at 406).

At 416, the TRP 436 uses TRP Beam B to transmit/receive Msg 2, Msg 3 and Msg 4 to/from the UE 200.

At 418, the RRC connection has been re-established, and at 430, the UE 200 may proceed with any PDCCH/PDSCH and/or PUCCH/PUSCH operations (operation 420) on the TRP Beam B.

A box 422 encapsulates operations, where the UE 200 has identified a need to transmit a UEIBR.

After experiencing failure at 410, at 423 the UE 200 may determine to initiate a RACH procedure on a dedicated beam that is not reported in the UEIBR. In other words, the RACH procedure and the transmission of the UEIBR is performed on a beam (the TRP Beam B) that is not a preferred beam (the TRP Beam C), or a beam that is not in the UEIBR. In this case, the TRP Beam B may be good enough for transition, recovery or handover, but it is not the best measured beam. This may be due to, for example, scheduling restrictions.

At 424, the UE 200 may transmit a RACH preamble, similarly to the operation 414. The preamble may be, for example, a preamble from the other one of the two different sets of uplink preambles and/or occasions as described in reference to previous embodiments.

At 426, Msg 2, Msg 3 and Msg 4 operations are performed on the TRP Beam B.

At 430, the UEIBR is transmitted on the TRP Beam B and at 432, a TCI is transmitted to the UE 200 on the TRP Beam B that indicates a switch to the TRP Beam C to the UE 200.

Finally, at 434, the UE 200 and the TRP 436 may proceed PDCCH/PDSCH and/or PUCCH/PUSCH communications on TRP Beam C, as indicated by the TCI.

FIG. 5 illustrates a signalling diagram between a user equipment 200 and a transmission reception point comprising three different beams according to an example embodiment. The signalling diagram is similar to the signalling diagram 400 of FIG. 4 with a few exceptions in the mechanism by which the RACH and/or UEIBR is transmitted.

At 502, UE 200 is RRC connected to TRP Beam A and at 504, the TRP 536 may configure (on TRP Beam B) the UE 200 for UEIBR transmission.

At 506, the TRP 536 may configure the UE 200 with two different resource sets for an uplink signal for an RACH procedure and a request of uplink resources for a user equipment initiated beam reporting procedure. In an example, the TRP 536 may transmit two different sets of uplink preambles and/or occasions for the uplink signal for the RACH procedure and the request of uplink resources for the user equipment initiated beam reporting procedure.

At 508, the UE 200 and the TRP 536 communicate PDCCH/PDSCH and/or PUCCH/PUSCH on TRP Beam A.

After experiencing a failure at 510, the UE 200 may perform operations enclosed by a box 512 (case 1), or perform operations enclosed by a box 522 (case 2).

The box 512 encapsulates operations for a case, where the UE 200 has identified that there is no need to transmit the UEIBR.

The UE 200 may choose a beam for, for example, a RACH preamble transmission (e.g. CFRA) only, which may correspond to a best measured beam (at 308) by the UE 200 (highest L1-RSRP/L1-SINR/PHR/RI etc.). The RACH preamble may be, for example, one preamble from a first set of uplink preambles and/or occasions of the two different sets of uplink preambles and/or occasions for the uplink signal for the RACH procedure and the request of uplink resources for the user equipment initiated beam reporting procedure obtained by the UE 200 in reference to previously described embodiments.

At 514, the UE 200 transmits a RACH preamble except any preamble dedicated for the RACH and UEIBR transmission.

At 516, the TRP 536 uses the TRP Beam B to transmit/receive Msg 2, Msg 3 and Msg 4 to/from the UE 200.

At 518, the RRC connection has been re-established, and at 530, the UE 200 may proceed with any PDCCH/PDSCH and/or PUCCH/PUSCH operations (operation 520) on the TRP Beam B.

A box 522 encapsulates operations, wherein the UE 200 has identified a need to transmit a UEIBR.

After experiencing a failure at 510, at 523 the UE 200 may determine to initiate a RACH procedure on a dedicated beam that is not reported in the UEIBR.

At 524, the UE 200 transmits a RACH preamble with dedicated RACH preamble and/or dedicated RACH occasion (configured at 506). The dedicated RACH preamble may be, for example, one preamble from a second set of uplink preambles and/or occasions of the two different sets of uplink preambles and/or occasions for the uplink signal for the RACH procedure and the request of uplink resources for the user equipment initiated beam reporting procedure.

At 526, Msg 2, Msg 3 and Msg 4 operations are performed on the TRP Beam B. Optionally, Msg 2 (DL from the network to the UE) may comprise additional resources for transmitting the UEIBR.

At 528, RRC connection has been (re-)established.

At an optional operation 530, a downlink control information (DCI) message may comprise the resources for the UEIBR transmission.

At 532, the UEIBR is transmitted on TRP Beam B with additional resources associated to dedicated RACH preamble and/or RACH occasion. In other words, the RACH preamble sent at 526 triggers the network node to allocate the additional resources for transmitting the UEIBR at 532.

At 534, a TCI may be transmitted to the UE 200 on the TRP Beam B that indicates a switch to the TRP Beam C to the UE 200.

Finally, at 536, the UE 200 and the TRP 536 may proceed PDCCH/PDSCH and/or PUCCH/PUSCH communications on the TRP Beam C, as indicated by the TCI.

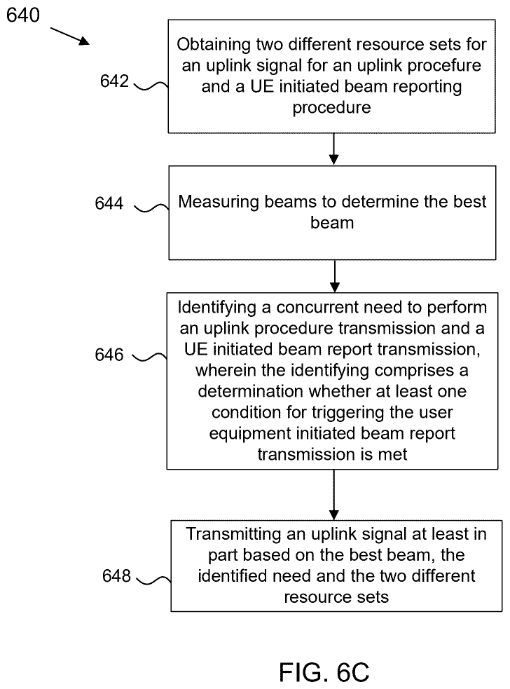

FIG. 6A illustrates a method 600 according to an example embodiment.

At 602, the method 600 may comprise obtaining, from a network node, at least one resource set.

At 604, the method 600 may comprise identifying a concurrent need to perform an uplink procedure transmission and a user equipment initiated beam report transmission.

At 606, the method 600 may comprise transmitting an uplink signal at least in part based on the identified need and the at least one resource set.

FIG. 6B illustrates a method 620 according to an example embodiment. The method 620 may be performed, for example, by the UE 200.

At 622, the method 620 may comprise obtaining, from a network node, two different resource sets for an uplink signal for an uplink procedure and a request of uplink resources for a user equipment initiated beam reporting procedure.

At 624, the method 620 may comprise identifying a concurrent need to perform an uplink procedure transmission and request uplink resources for a user equipment initiated beam report transmission.

At 626, the method 620 may comprise transmitting an uplink signal at least in part based on the identified need and the two different resource sets.

FIG. 6C illustrates a method 640 according to an example embodiment. The method 640 may be performed, for example, by the UE 200.

At 642, the method 640 may comprise obtaining, from a network node, two different resource sets for an uplink signal for an uplink procedure and a user equipment initiated beam reporting procedure.

At 644, the method 640 may comprise measuring beams to determine the best beam. The best beam may a beam having a highest signal metric. The signal metric may comprise, for example, layer 1 or layer 3 reference signal received power value or a layer 1 or layer 3 signal to interference and noise ratio value.

At 646, the method 640 may comprise identifying a concurrent need to perform an uplink procedure transmission and a user equipment initiated beam report transmission, wherein the identifying comprises a determination whether at least one condition for triggering the user equipment initiated beam report transmission is met. The at least one condition may comprise, for example, a condition that the best beam is x dB better than the current beam.

At 648, the method 640 may comprise transmitting the uplink signal at least in part based on the best beam, the identified need and the two different resource sets. In an example embodiment, the UE may be configured to choose among resources, for example, CFRA resources, associated with CSI-RS beams the one associated with the fastest recovery, i.e. the fastest RACH occasion to reduce latency. If the fastest resource is associated with the same beam than the best beam measured by the UE, the UE may be configured to use a first resource set for a RACH transmission only and send the RACH preamble. If the fastest resource is not associated with the same beam than the best beam measured by the UE, the UE may be configured to use a second resource set for RACH and user equipment initiated beam report transmissions and send the RACH preamble followed by the user equipment initiated beam report.

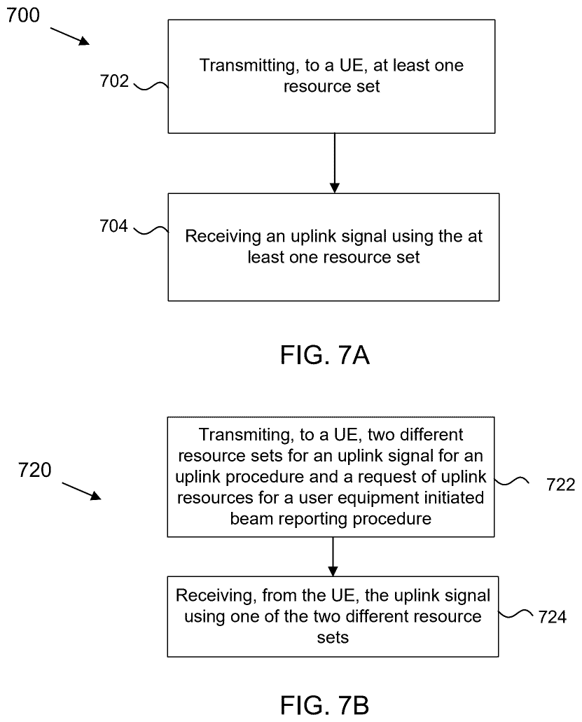

FIG. 7A illustrates a method 700 according to an example embodiment. The method 700 may be performed, for example, by the network node 220.

At 702, the method 700 may comprise transmitting, to a user equipment, at least one resource set.

At 704, the method 700 may comprise receiving an uplink signal using the at least one resource set.

FIG. 7B illustrates a method 720 according to an example embodiment. The method 720 may be performed, for example, by the network node 220.

At 722, the method 720 may comprise transmitting, to a user equipment, two different resource sets for an uplink signal for an uplink procedure and a request of uplink resources for a user equipment initiated beam reporting procedure.

At 724, the method 720 may comprise receiving, from the user equipment, the uplink signal using one of the two different resource sets.

Another example of an apparatus suitable for carrying out the embodiments and examples of the UE 200 side, with regards to FIG. 3, FIG. 4 and FIG. 5 may comprise at least means for: obtaining, from a network node, at least one resource set for an uplink signal for an uplink procedure and a user equipment initiated beam reporting procedure; identifying a concurrent need to perform an uplink procedure transmission and a user equipment initiated beam report transmission; and transmitting the uplink signal at least in part based on the identified need and the at least one resource set.

Another example of an apparatus suitable for carrying out the embodiments and examples of the UE 200 side, with regards to FIG. 3, FIG. 4 and FIG. 5 may comprise at least means for: obtaining, from a network node, two different resource sets for an uplink signal for an uplink procedure and a request of uplink resources for a user equipment initiated beam reporting procedure; identifying a concurrent need to perform an uplink procedure transmission and request uplink resources for a user equipment initiated beam report transmission; and transmitting an uplink signal at least in part based on the identified need and the two different resource sets.

Another example of an apparatus suitable for carrying out the embodiments and examples of the UE 200 side, with regards to FIG. 3, FIG. 4 and FIG. 5 may comprise at least means for: obtaining, from a network node, two different resource sets for an uplink signal for an uplink procedure and a user equipment initiated beam reporting procedure; measuring beams to determine the best beam; identifying a concurrent need to perform an uplink procedure transmission and a user equipment initiated beam report transmission, wherein the identifying comprises a determination whether at least one condition for triggering the user equipment initiated beam report transmission is met; and transmitting the uplink signal at least in part based on the best beam, the identified need and the two different resource sets.

The means may comprise, for example, a combination of the at least one processor 202, the at least one memory 204 and the at least one transceiver 206.

Another example of an apparatus suitable for carrying out the embodiments and examples of the network side, with regards to FIG. 3, FIG. 4 and FIG. 5 may comprise at least means for: transmitting, to a user equipment, at least one resource set; and receiving the at least one uplink signal using a set of resources of the at least one resource set.

Another example of an apparatus suitable for carrying out the embodiments and examples of the network side, with regards to FIG. 3, FIG. 4 and FIG. 5 may comprise at least means for: transmitting, to a user equipment, two different resource sets for an uplink signal for an uplink procedure and a request of uplink resources for a user equipment initiated beam reporting procedure; and receiving, from the user equipment, the uplink signal using one of the two different resource sets.

The means may comprise, for example, a combination of the at least one processor 222, the at least one memory 224 and the at least one transceiver 226.

One or more of the example and example embodiments discussed above may enable a solution which enables a UE to be connected on the best beam faster and more reliably than with the CBRA procedure, if the UE preferred beam (selected for the UEIBR) is not a beam allocated with CFRA resources. Thanks to the dedicated CFRA resources for the RACH and UEIBR, the UE takes the earliest CFRA RACH occasion (even if not the beam measured with highest L1-RSRP/L1-SINR, PHR, RI) and indicates in parallel that there is a better beam and also which one is the preferred beam with subsequent UEIBR. The network can then switch TCI to the preferred beam after the UE is connected. Any range or device value given herein may be extended or altered without losing the effect sought. Also, any embodiment may be combined with another embodiment unless explicitly disallowed.

Furthermore, one or more example embodiments discussed above may enable a solution which reduces the time it takes for a UE to be connected on the best beam.

Furthermore, one or more example embodiments discussed above may enable a solution, which reduces signalling overhead or resource occupancy/allocation. For example, CBRA, DL reference signal, periodic beam management reports and TCI switching is slower than the solutions provided herein (e.g., CFRA+UEIBR).

Furthermore, one or more embodiments discussed above provides a reliable solution in contrast to legacy solutions. For example, the CFRA+UEIBR procedure combination discussed herein may provide the best communication conditions, whereas legacy solutions, such as CBRA+periodic beam management reporting requires the network to first be able to manage the contention based RACH for the device connected to the network, before solving the best beam for the device, later received in the periodic beam management report from the device. As the CBRA procedure is a contention based procedure, multiple users may use the same preamble and the contention may not be resolved at the network side. This is not an issue with the discussed CFRA+UEIBR procedure, making the CFRA+UEIBR procedure a reliable solution.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the embodiments described above may be combined with aspects of any of the other embodiments described to form further embodiments without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A user equipment, comprising:
at least one processor; and
at least one memory storing instructions which, when executed by the at least one processor, cause the user equipment at least to:
obtain, from a network node, two different resource sets for an uplink signal for an uplink procedure and a user equipment initiated beam re-porting procedure;
measure beams to determine the best beam;
identify a concurrent need to perform an uplink procedure transmission and a user equipment initiated beam report transmission, wherein the identifying comprises a determination whether at least one condition for triggering the user equipment initiated beam report transmission is met; and
transmit the uplink signal at least in part based on the best beam, the identified need and the two different resource sets.

2. The user equipment according to claim 1, wherein the two different resource sets comprise a first resource set configured only for the uplink procedure and a second resource set configured for both the uplink procedure and the user equipment initiated beam reporting procedure.

3. The user equipment according to claim 2, in response to identifying the concurrent need to perform the uplink procedure transmission and the user equipment initiated beam report transmission, the user equipment is configured to transmit the up-link signal using the first resource set.

4. The user equipment according to claim 3, the at least one memory storing instructions which, when executed by the at least one processor, cause the user equipment at least to:
determine among resources associated with downlink reference signal beams the resource associated with the earliest random access channel occasion; and
transmit the uplink signal using the first set of resources configured only for the uplink procedure when the resource associated with the earliest random access channel occasion is associated with the best beam.

5. The user equipment according to claim 3, the at least one memory storing instructions which, when executed by the at least one processor, cause the user equipment at least to:
identify that the beam used for transmitting the uplink signal for the uplink procedure is the same as the best beam to be reported in a user equipment initiated beam report; and
omit reporting of the user equipment initiated beam report or transmit the uplink signal only.

6. The user equipment according to claim 2, in response to identifying the concurrent need to perform the uplink procedure transmission and the user equipment initiated beam report transmission, the user equipment is configured to transmit the up-link signal using the second resource set configured for both the uplink procedure and the user equipment initiated beam reporting procedure.

7. The user equipment according to claim 6, the at least one memory storing instructions which, when executed by the at least one processor, cause the user equipment at least to:
determine among resources associated with downlink reference signal beams the resource associated with the earliest random access channel occasion; and
transmit the uplink signal using the second set of resources configured for both the uplink procedure and the user equipment initiated beam reporting procedure when the resource associated with the earliest random access channel occasion is not associated with the best beam.

8. The user equipment according to claim 6, the at least one memory storing instructions which, when executed by the at least one processor, cause the user equipment at least to:
identify that a beam used for transmitting the uplink signal for the uplink procedure is different than the best beam to be reported in a user equipment initiated beam report; and
transmit the user equipment initiated beam report using the second resource set.

9. The user equipment according to claim 6, wherein the instructions, when executed by the at least one processor, further cause the user equipment at least to:
receive a transmission configuration indicator from the network node, wherein the transmission configuration indicator indicates the best beam; and
apply the best beam in subsequent transmission and/or receiving operations.

10. The user equipment according to claim 1, wherein the best beam has a higher signal metric than that of the first beam.

11. The user equipment according to claim 10, wherein the signal metric comprises:
a layer 1 or layer 3 reference signal received power value; or
a layer 1 or layer 3 signal to interference and noise ratio value.

12. The user equipment according to claim 1, wherein the best beam is a beam having a highest signal metric, wherein the signal metric comprises:
a layer 1 or layer 3 reference signal received power value; or
a layer 1 or layer 3 signal to interference and noise ratio value.

13. The user equipment according to claim 1, wherein the uplink procedure comprises a contention free random access procedure or a contention based random access procedure.

14. The user equipment according to claim 1, wherein the at least two different resource sets comprise different preambles.

15. A method comprising:
obtaining, from a network node, two different resource sets for an uplink signal for an uplink procedure and a user equipment initiated beam re-porting procedure;
measuring beams to determine the best beam;
identifying a concurrent need to perform an uplink procedure transmission and a user equipment initiated beam report transmission, wherein the identifying comprises a determination whether at least one condition for triggering the user equipment initiated beam report transmission is met; and
transmitting the uplink signal at least in part based on the best beam, the identified need and the two different resource sets.

16. The method according to claim 15, wherein the two different resource sets comprise a first resource set configured only for the uplink procedure and a second resource set configured for both the uplink procedure and the user equipment initiated beam reporting procedure, and in response to identifying the concurrent need to perform the uplink procedure transmission and the user equipment initiated beam report transmission, the method comprises transmitting the up-link signal using the first resource set.

17. The method according to claim 16, further comprising:
determining among resources associated with downlink reference signal beams the resource associated with the earliest random access channel occasion; and
transmitting the uplink signal using the first set of resources configured only for the uplink procedure when the resource associated with the earliest random access channel occasion is associated with the best beam.

18. The method according to claim 16, further comprising:
identifying that the beam used for transmitting the uplink signal for the uplink procedure is the same as the best beam to be reported in a user equipment initiated beam report; and
omitting reporting of the user equipment initiated beam report or transmit the uplink signal only.

19. The method according to claim 15, wherein the two different resource sets comprise a first resource set configured only for the uplink procedure and a second resource set configured for both the uplink procedure and the user equipment initiated beam reporting procedure, and in response to identifying the concurrent need to perform the uplink procedure transmission and the user equipment initiated beam report transmission, the method comprises transmitting the up-link signal using the second resource set configured for both the uplink procedure and the user equipment initiated beam reporting procedure.

20. A non-transitory computer readable medium comprising instructions stored thereon for performing at least the following:
obtaining, from a network node, two different resource sets for an uplink signal for an uplink procedure and a user equipment initiated beam re-porting procedure;
measuring beams to determine the best beam;
identifying a concurrent need to perform an uplink procedure transmission and a user equipment initiated beam report transmission, wherein the identifying comprises a determination whether at least one condition for triggering the user equipment initiated beam report transmission is met; and
transmitting the uplink signal at least in part based on the best beam, the identified need and the two different resource sets.
